(19) United States
(12) Patent Application Publication
(10) Pub. No.: US 2007/0083367 A1
(43) Pub. Date: Apr. 12, 2007

(54) Method and system for bandwidth efficient and enhanced concatenative synthesis based communication

(75) Inventors: Daniel A. Baudino, Lake Worth, FL (US); Deepak P. Ahya, Plantation, FL (US); Adeel Mukhtar, Coral Springs, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/247,543

(22) Filed: Oct. 11, 2005

(51) Int. Cl. G10L 15/26

(52) U.S. Cl. 704/235

(57) ABSTRACT

A voice communication system and method for improved bandwidth and enhanced concatenative speech synthesis includes a transmitter (10) having a voice recognition engine (12) that receives speech and provides text, a voice segmentation module (24) that segments the speech into a plurality of speech units or snippets, a database (18) for storing the snippets, a voice parameter extractor (28) for extracting among rate or gain, and a data formatter (20) that converts text to snippets and compresses snippets. The data formatter can merge snippets and text into a data stream. The system can further include at a receiver (50) an interpreter (52) for extracting parameters, text, voice, and snippets from the data stream, a parameter reconstruction module (54) for detecting gain and rate, a text to speech engine (56), and a second database (58) that is populated with snippets from the data stream that are missing in the second database

### FIELD OF THE INVENTION

This invention relates generally to voice communications, and more particularly to a bandwidth efficient method and system of communication using speech units such as diphones, triphones, or phonemes.

### BACKGROUND OF THE INVENTION

On wireless telecommunication systems, bandwidth (BW) is very expensive. There are many techniques for compressing audio to maximize bandwidth utilization. Often, these techniques provide either low quality voice with reduced BW or high quality voice with high BW.

### SUMMARY OF THE INVENTION

Embodiments in accordance with the present invention can provide utilize known voice recognition and concatenative text to speech (TTS) synthesis techniques in a bandwidth efficient manner that provides high quality voice. In most embodiments herein, systems herein can improve bandwidth efficiency over time without necessarily degrading voice quality.

In a first embodiment of the present invention, a method for improved bandwidth and enhanced concatenative speech synthesis in a voice communication system can include the steps of receiving a speech input, converting the speech input to text using voice recognition, segmenting the speech input into speech units such as diphones, triphones or phonemes, comparing the speech units with the text and with stored speech units in a database, combining speech units with the text in a data stream if the speech unit is a new speech unit to the database, and transmitting the data stream. The new speech units can be stored in the database and if the speech unit is an existing speech unit in the database, then it does not need to be transmitted in the datastream. The method can further include the step of extracting voice parameters among speech rate or gain for each speech unit where the gain can be determined by measuring an energy level for each speech unit and the rate can be determined from a voice recognition module. The method can further include the step of determining if a new voice is detected (the speech input is for a new voice) and resetting the database. Note, the speech units can be compressed and stored in the database and transmitted. This method can be done at a transmitting device. The method can also increase efficiency in terms of bandwidth use by increasingly using stored speech units as the database becomes populated with speech units.

In a second embodiment of the present invention, another method for improved bandwidth and enhanced concatenative speech synthesis in a voice communication system can include the steps of extracting data into parameters, text, voice and speech units, forwarding speech units and parameters to a text to speech engine, storing a new speech unit missing from a database into the database, and retrieving a stored speech unit for each text portion missing an associated speech unit from the data. The method can further include the step of comparing a speech unit from the extracted data with speech unit stored in the database. From the parameters sent to a text to speech engine, the method can further include the step of reconstructing prosody. Note, this method can be done at a receiving device such that the database at a receiver can be synchronized with a database at a transmitter. The method can further include the step of recreating speech using the new speech units and the stored speech units. Further note that the database can be reset if a new voice is detected from the extracted data.

In a third embodiment of the present invention, a voice communication system for improved bandwidth and enhanced concatenative speech synthesis in a voice communication system can include at a transmitter a voice recognition engine that receives a speech input and provides a text output, a voice segmentation module coupled to the voice recognition engine that segments the speech input into a plurality of speech units, a speech unit database coupled to the voice segmentation module for storing the plurality of speech units, a voice parameter extractor coupled to the voice recognition engine for extracting among rate or gain or both, and a data formatter that converts text to speech units and compresses speech units using a vocoder. The data formatter can merge speech units and text into a single data stream. The system can further include at a receiver an interpreter for extracting parameters, text, voice, and speech units from the data stream, a parameter reconstruction module coupled to the interpreter for detecting gain and rate, a text to speech engine coupled to the interpreter and parameter reconstruction module, and a second speech unit database that is further populated with speech units from the data stream that are missing in the second speech unit database. The receiver can further include a voice identifier that can reset the database if a new voice is detected from the data stream. Note, the second speech unit database can be synchronized with the speech unit database.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a block diagram of a transmitter using an improved bandwidth efficient method of voice communication in accordance with an embodiment of the present invention.

FIG. 2 is a chart illustrating how energy or gain can be measured for each phoneme or diphone or triphone in accordance with an embodiment of the present invention.

FIG. 3 is a more detailed block diagram of a data formatter using in the transmitter of FIG. 1 in accordance with an embodiment of the present invention.

FIG. 4 is a block diagram of a receiver using an improved bandwidth efficient and enhanced concatenative speech synthesis method of voice communication in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

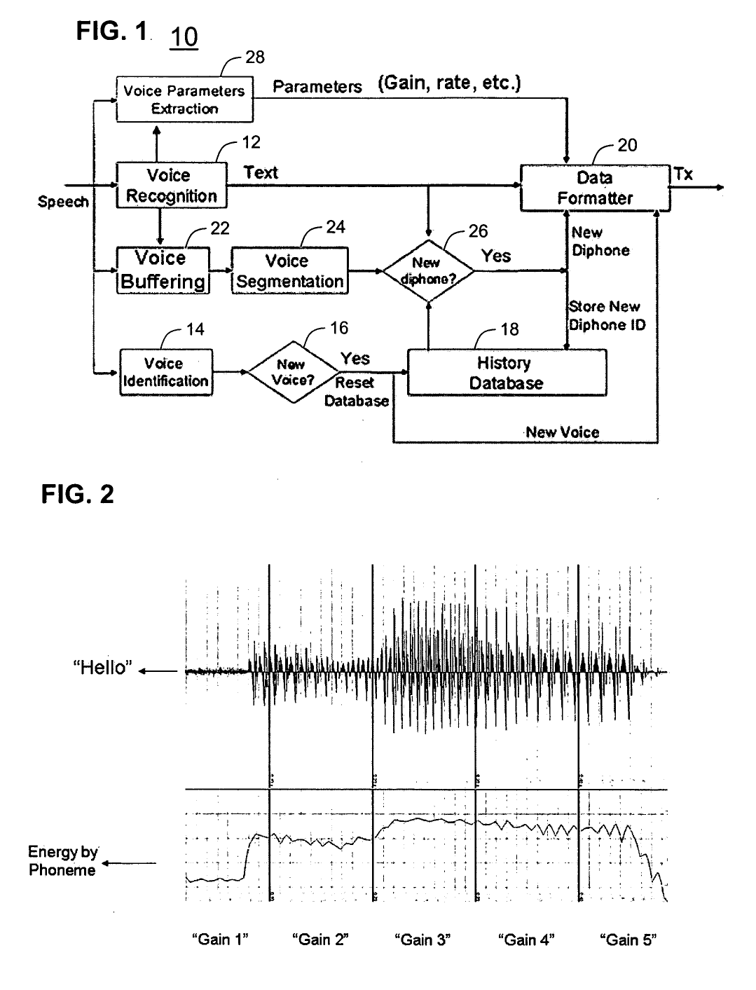

In wired or wireless IP networks, traffic conditions or congestion can be improved upon using a bandwidth efficient communication technique that also provides reasonable speech voice quality as described herein. Embodiments herein can use Voice Recognition and concatenative TTS synthesis techniques to efficiently use BW. Methods in accordance with the present invention can use snippets or speech units of pre-recorded voice from a transmitter end the bits of pre-recorded voice can be put together at a receiver end. The snippets or speech units can be diphones, triphones, syllables, or phonemes for example. Diphones are usually a combination of two sounds. In general American English there are 1444 possible diphones. For example, “tip”, “steep”, “spit”, “butter”, and “button” involve five different pronunciations of “t”. At a transmitter 10 as illustrated in FIG. 1, the diphones or other speech units are recorded and pre-stored in a history database 18. Every time a new diphone or speech unit is encountered, it is stored and transmitted.

Referring again to FIG. 1, the transmitter receives a speech input that goes into a voice recognition module 12 that recognizes speech and sends text to a data formatter 20. At the same time, the speech is recorded or placed into a voice buffer 22, and segmented into speech units such as diphones at a voice segmentation module 24. Although diphones are used as the primary example in the embodiments herein, it should be understood that other speech units are certainly within the contemplation and scope of the appended claims. Each diphone can be compared (at a comparison block 26) with the output of the voice recognition module 12 and against the diphones stored in the history database 18 to identify if the diphone exist on the history database 18. If the diphones does not exist or is missing from the history database 18, then diphone is combined, attached or appended with the text (Phoneme or word) where it belongs and then transmitted. At the same time the diphone is also stored in the local history database 18 for future use. The transmitter can also include a voice identification module 14 that identifies the speech input from a particular source. If a new voice is detected at comparison block 16, then the history database 18 can be reset with either a cleared database or a another history database corresponding to the newly identified voice. Also note that the history database 18 can be cleared after the voice communication or call is terminated. The Voice identification module 14 can reset the database 18 when a new voice is detected during the call to ensure device can be used by multiple users in a single call or session.

The transmitter 10 can further include a voice parameter extraction module 28 that obtains information about at least speech rate and gain. The gain of the speech is extracted and it is sent with the text for later prosodic reconstruction (Stress, accentuation, etc.). Energy for each phoneme or diphone can be easily measured to determine the gain per snippet (phoneme or diphone). The chart of FIG. 2 illustrates how energy or gain can be measured per phoneme. The rate can be extracted from the voice recognition module 12. The voice recognition module 12 converts the speech to text, so it can easily identify how many words per minute/second are converted. The Voice parameter extraction can convert the words per minute to diphone (or other speech unit) per minute if needed. Of course, other voice parameters can be extracted as is known in the art.

With respect to the voice segmentation module 24, there are many ways of doing voice segmentation using Voice recognition. Voice recognition software can perform recognition and link the word to corresponding phoneme and audio. Once the phoneme is detected, a diphone can be formed. As noted previously, diphones are a combination of 2 phonemes.

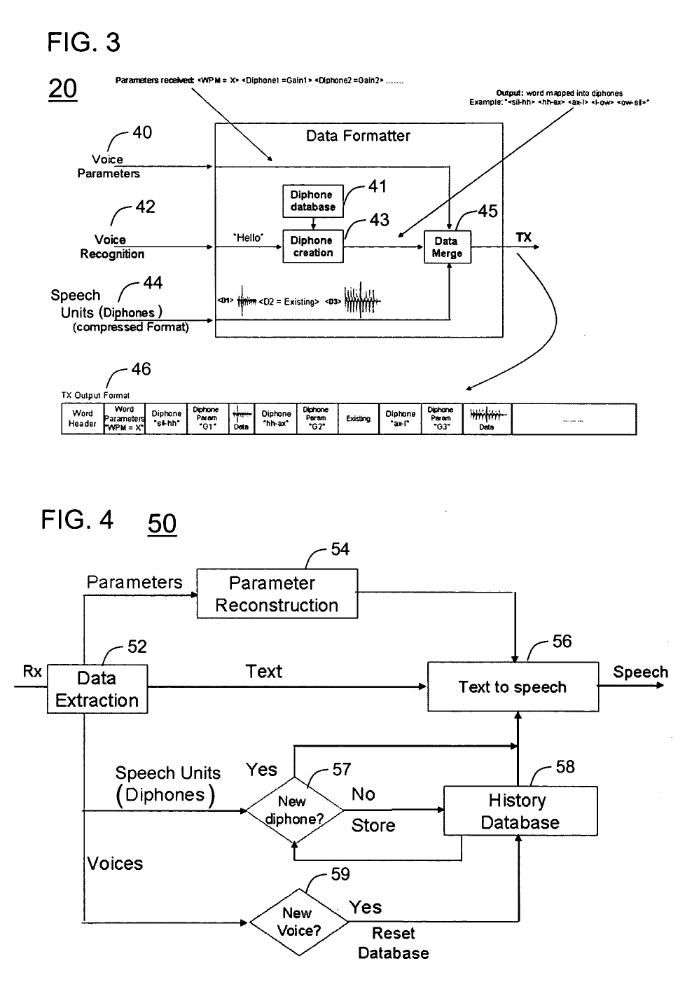

Referring to FIG. 3, a more detailed view of the data formatter 20 is illustrated in FIG. 3. The data formatter 20 can include as inputs, the following: Voice Parameters 40 that can include gain per diphone or phoneme depending on the quality of the naturalness required, and rate in terms of word per minute (WPM) or per diphone. The WPM can be updated by word, sentence, etc; Text string 42 that includes text converted by the Voice Recognition module 12. The text is converted to diphones using the diphone creation module 43 or obtained from pre-stored diphone database 41; and Diphones 44 that can be compressed using any known encoding technique (vocoder). Thus, the voice parameters 40, diphones converted from text input 42, and the diphones 44 are merged at data merge module 45 to provide a data stream in a predetermined format 46. The data is separated by diphones. If a particular diphone exists on the database 41, then it is indicated on the format 46. The text string can be separated by diphones and then synchronized with the gain (per diphone) and with the audio by diphones.

Note, any Voice recognition engine (with dictation capabilities) is acceptable for the module 12 of FIG. 1. Also note that the history database 18 or 41 can keep track of all the diphones already detected previously. When a diphone is detected on the database (18 or 41), a blank can be inserted on the diphone stream indicating that the diphone is “existent”. Also note that the voice identification module 14 can use any number of very well known techniques.

At a receiver 50 as illustrated in FIG. 4, the data can be separated or extracted by an interpreter or data extraction module 52 (into parameters, text, voice, and speech units such as diphones) and the diphones received are sent to a text to speech (TTS) engine 56. The TTS engine 56 can be any number of well known concatenative TTS engines. The module 52 can detect all inputs (parameters, text, voice, and diphones) embedded on the main data stream and send them to the appropriate module. If the diphones do not exist on a second or receiver history database 58 as determined by comparison block 57, they are then stored for later use. If the text received does not contain a diphone associated with it, it is retrieved from the database 58. The parameters received (gain, time, etc) are sent to a parameter reconstruction module 54 that is in charge of detecting the gain and the rate (wpm) that is then used to adjust the gain and rate of the TTS engine for prosody reconstruction. If a new voice is received, voice identity module 59 will clear the database.

The efficiency of the method of communication in accordance with several of the embodiments herein will be low at the beginning of a call, will increase as the call continues as it reaches a steady state condition where no diphones are sent at all and transmission consists of text, speech rate, and gain info. Both history databases can be synchronized in case of packet loss. Hence, the receiver in a synchronized scenario has to acknowledge every time that a diphone is received. If the transmitter does not get the acknowledgement from the receiver, then the diphone can be deleted from the local (transmit side) database (18 or 41). If a diphone is not received, a pre-recorded diphone can be used on the receiver side (50). The pre-recorded diphone database 58 can have all the diphones and can be used in combination with received diphones in case of packet loss. Note, embodiments herein can use any method of voice compression to reduce the size of the diphone to be sent.

Every TTS system has a pre recorded database with all the speech units (diphones). In embodiments herein, the database 58 will serve the TTS engine 56 except that the speech units or diphones are not all present at the beginning. The database 58 gets populated during the communication. This can be totally transparent to the TTS engine 56. Every time that the TTS engine 56 requests a diphone or other speech unit, it will be available whether it is obtained from the database 58 or freshly extracted from the data stream. The diphones or other speech units are stored in compressed format at the history database 58 to reduce the memory usage on the receiver 50.

Note, using the embodiments herein that the voice prosody (stress, intonation) is degraded where the amount of degradation will depend on the BW used. To improve the voice quality, the number of voice parameters transmitted (related to the voice prosody such as pitch) can be increased; hence the quality will improve with some effect to BW. The overall BW is variable and improves with time. Each diphone or speech unit that is repeated (existing on the database) is not necessarily transferred again. After the most common diphones or speech units have been transferred, the BW is reduced to a minimum level.

To determine a worst case scenario for bandwidth, note the following:

The worst case BW is:

Parameters: (based on an average of 7 diphones a second)

| | | | |
|---|---|---|---|
| Rate: | 49 | bps | 7 Bits per diphone |
| Gain: | 35 | bps | 5 bits per diphone |
| Text: | aprox. 280 | bps (*) | |
| Diphone: | 4400 | bps | 616 bits per diphone [diphone |
| | | | duration of 140 ms avg] × 7 = |
| | | | 4312 bps |

| | |
|---|---|
| Overhead: | 10% |

| | | |
|---|---|---|
| Max. BW | aprox. 5.2 | kbps |

(*) For example: Mean diphone duration = 140 ms -> Avg. of 7 diphones per second considering and an avg. of 5 bytes per diphone.

At the beginning, the rate is equivalent to today's technology. But after a few seconds the rate can be drastically reduced (the diphones start to exist or populate on the database). After the database is populated with the most frequent diphones (500 diphones), the rate is lowered to 500 bps (approximated). After the most frequent diphones are received, if a non-existent diphone is received, the rate will have peaks of 1000 bps. Note, a complete conversation can be made using only 1300 diphones from a total of 1600.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method for improved bandwidth and enhanced concatenative speech synthesis in a voice communication system, comprising the steps of:
receiving a speech input;
converting the speech input to text using voice recognition;
segmenting the speech input into speech units;
comparing the speech units with the text and with stored speech units in a database;
combining a speech unit with the text in a data stream if the speech unit is a new speech unit to the database; and
transmitting the data stream.

2. The method of claim 1, wherein the method further comprises the step of storing the new speech unit in the database, wherein the speech unit is among a diphone, a triphone, a syllable, or a phoneme.

3. The method of claim 1, wherein the method further comprises the step of transmitting just text if the speech unit is an existing speech unit in the database.

4. The method of claim 1, wherein the method further comprises the step of extracting voice parameters among speech rate or gain for each speech unit.

5. The method of claim 1, wherein the method further comprises the step of determining if the speech input is for a new voice and resetting the database if the speech input is the new voice.

6. The method of claim 4, wherein the method further comprises the step of determining gain by measuring an energy level for each speech unit.

7. The method of claim 4, wherein the method further comprises the step of determining speech rate from a voice recognition module.

8. The method of claim 4, wherein the method further comprises the step of compressing speech units stored in the database and transmitted.

9. A method for improved bandwidth and enhanced concatenative speech synthesis in a voice communication system, comprising the steps of:
extracting data into parameters, text, voice and speech units;
forwarding speech units and parameters to a text to speech engine;
storing a new speech unit missing from a database into the database; and
retrieving a stored speech unit for each text portion missing an associated speech unit from the data.

10. The method of claim 9, wherein the method further comprises the step of comparing a speech unit from the extracted data with speech units stored in the database.

11. The method of claim 9, wherein the method further comprises the step of reconstructing prosody from the parameters sent to a text to speech engine.

12. The method of claim 9, wherein the method further comprises the step of resetting the database if a new voice is detected from the voice from the extracted data.

13. The method of claim 9, wherein the method further comprises the step of synchronizing the database at a receiver with a database at a transmitter.

14. The method of claim 9, wherein the method further comprises the step of recreating speech using the new speech units and the stored speech units.

15. The method of claim 9, wherein the method comprises the step of increasing efficiency in bandwidth use by increasingly using stored speech units as the database becomes populated with speech units.

16. A voice communication system for improved bandwidth and enhanced concatenative speech synthesis in a voice communication system, comprising at a transmitter:
a voice recognition engine that receives a speech input and provides a text output’
a voice segmentation module coupled to the voice recognition engine that segments the speech input into a plurality of speech units;
a speech unit database coupled to the voice segmentation module for storing the plurality of speech units;
a voice parameter extractor coupled to the voice recognition engine for extracting among rate or gain or both; and
a data formatter that converts text to speech units and compresses speech units using a vocoder.

17. The system of claim 16, wherein the data formatter further merges speech units and text into a single data stream.

18. The system of claim 17, wherein the system further comprises at a receiver:
an interpreter for extracting parameters, text, voice, and speech units from the single data stream;
a parameter reconstruction module coupled to the interpreter for detecting gain and rate;
a text to speech engine coupled to the interpreter and parameter reconstruction module; and
a second speech unit database that is further populated with speech units from the data stream that are missing in the second speech unit database.

19. The system of claim 18, wherein the receiver further comprises a voice identifier that can reset the database if a new voice is detected from the data stream.

20. The system of claim 18, wherein the second speech unit database is synchronized with the speech unit database.
